(19) United States
(12) Patent Application Publication
(10) Pub. No.: US 2024/0417526 A1
(43) Pub. Date: Dec. 19, 2024

(54) THERMOPLASTIC RESIN COMPOSITION PELLET AND METHOD FOR PRODUCING SAME

(71) Applicants: Mitsubishi Chemical Corporation, Tokyo (JP); MATSUMOTO YUSHI-SEIYAKU CO., LTD., Yao-shi (JP)

(72) Inventors: Fumihiro MUTO, Hiratsuka-shi (JP); Masaru TAKEHANA, Hiratsuka-shi (JP); Yu KITA, Yao-shi (JP)

(73) Assignees: Mitsubishi Chemical Corporation, Tokyo (JP); MATSUMOTO YUSHI-SEIYAKU CO., LTD., Yao-shi (JP)

(21) Appl. No.: 18/701,769

(22) PCT Filed: Oct. 27, 2022
(86) PCT No.: PCT/JP2022/040145

§ 371 Date: Apr. 16, 2024

(30) Foreign Application Priority Data
Oct. 28, 2021 (JP) 2021-176805
Oct. 28, 2021 (JP) 2021-176806
Oct. 28, 2021 (JP) 2021-176807

(51) Int. Cl. C08J 9/232; C08J 3/22; C08J 9/00; C08L 25/06; C08L 67/02

(52) U.S. Cl. CPC C08J 9/232; C08J 3/226; C08J 9/0061; C08J 9/0085; C08L 25/06; C08L 67/02; C08J 2201/03; C08J 2203/22; C08J 2325/06; C08J 2367/02; C08J 2467/02; C08L 2203/14; C08L 2310/00

(57) ABSTRACT

A thermoplastic resin composition pellet may include 30 to 100 parts by mass of a polybutylene terephthalate resin (A) having an intrinsic viscosity of 0.3 to 1.3 dl/g and 0 to 70 parts by mass of a polystyrene or a rubber-reinforced polystyrene resin (B), and 0.5 to 20 parts by mass of heat-expandable microsphere (C) having a maximum expansion temperature in a range of 250 to 320° C. and an average particle diameter in a range of 10 to 50 μm, relative to 100 parts by mass of the total (A) and (B). A method may produce the thermoplastic resin composition pellet including melt kneading a master batch including the heat-expandable microsphere (C) and a thermoplastic resin with the polybutylene terephthalate resin (A) and the polystyrene or rubber-reinforced polystyrene resin (B).

### TECHNICAL FIELD

The present invention relates to a thermoplastic resin composition pellet; and a method for producing same, and more specifically relates to: a thermoplastic resin composition pellet which enables favorable foam molding on a molding company without blending a foaming agent at the time of molding; and a method for producing thermoplastic resin composition pellet, in which these thermoplastic resin composition pellet can be stably produced with favorable productivity.

### BACKGROUND ART

Polybutylene terephthalate resin exhibits excellent mechanical strength, chemical resistance, electrical insulating properties, and the like, and is therefore widely used in components for electrical and electronic equipment and motor vehicle interior and exterior component, and also in other electrical equipment component, mechanical component, and the like. Polyethylene terephthalate resin is primarily used to form extruded articles such as bottle, fiber, sheet and film, but polybutylene terephthalate resin exhibits particularly superior moldability to polyethylene terephthalate resin, and is therefore primarily used in injection molded articles, and is widely used in a variety of components by being injection molded.

Molded articles of polybutylene terephthalate resin are often used as replacements for metals in order to reduce weight, but there are strong demands for further weight reduction. For example, improving fuel economy is an obvious issue in the field of motor vehicle, and weight reduction is regarded as important for improving safety and comfort, and there are strong demands to reduce the weight of resin foam in order to achieve further weight reduction.

Examples of methods for obtaining resin foam include method including dissolving supercritical carbon dioxide or nitrogen in a resin so as to produce ultrafine foam cells at the time of injection molding, but these are not limited to extrusion foam molding and injection foam molding, which require specialist molding machine, and are generally carried out by dry blending an organic or inorganic foaming agent with a raw material resin prior to molding, and then simultaneously molding and foaming. However, when foaming and molding is carried out by molders that work in foam molding, dry blending a foaming agent in advance leads to additional complicated operations. In addition, problems tend to occur, such as the need to sort foaming agents and the weight and dimensions of molded articles not being stable. For molders, it is desirable for resin composition pellet, in which desired additives and a foaming agent are blended at precise quantities, to be supplied from a compounder, and a foam molding molder can produce, with favorable productivity, a favorable homogeneous polybutylene terephthalate resin foam molded article.

PTL 1 discloses an invention of a resin composition obtained by incorporating a dimensional stabilizer in a recycled polyethylene terephthalate resin, and indicates that a profile extrusion-molded article having excellent dimensional properties can be produced using extrusion molding. However, PTL 1 does not clearly suggest a method for mixing a recycled polyethylene terephthalate resin with heat-expandable microsphere or a master batch containing heat-expandable microsphere, and indicates that wetting with a liquid compound or the like is preferred, but in these methods, the problems of needing to sort a foaming agent and the risk of contaminating a molding machine hopper are not adequately solved. In addition, this invention is a technique for attempting to compensate for disadvantages in polyethylene terephthalate resin, e.g., melt viscosity and melt tension decreasing as the degree of recycling increases and crystallization being extremely slow, and this invention is not suitable for injection molding and cannot impart high levels of rigidity and strength required in automotive applications. Furthermore, because polyethylene terephthalate resin has higher melting point than polybutylene terephthalate resin, it is difficult to obtain resin composition pellet which is suitable for molding and which do not foam after being melt kneaded.

In addition to extrusion foam molding and injection foam molding, methods for obtaining foam molded articles are generally carried out by dry blending an organic or inorganic foaming agent with a raw material resin at the time of molding, and then melt kneading and foaming the same. However, when foaming and molding is carried out by molders that work in foam molding, dry blending a foaming agent in advance leads to additional complicated operations. For molders, it is desirable for resin composition pellet, in which desired additives and a foaming agent are blended at precise quantities, to be supplied from a compounder, and a foam molding molder can produce, with favorable productivity, a favorable homogeneous polybutylene terephthalate resin foam molded article.

Polybutylene terephthalate resin composition pellet is generally produced by melt kneading in an extruder, but the temperature when a crystalline polybutylene terephthalate resin is melt kneaded is similar to the temperature when a foaming agent implements forming, and problems can occur, e.g., foaming readily occurring inside the extruder. This problem is particularly prominent in the case of a reinforced system in which a reinforcing filler is blended in order to improve the mechanical strength, heat resistance, and so on, of a polybutylene terephthalate resin because a hard reinforcing filler stimulates a foaming agent and readily causes foaming and foam rupture.

### CITATION LIST

### Patent Literature

[PTL 1] JP 2014-019750 A

### SUMMARY OF INVENTION

### Technical Problem

There are currently no known methods for producing a favorable foam molded article through injection molding directly from polybutylene terephthalate resin composition pellet without dry blending a foaming agent or the like.

The purpose of the present invention is to solve the problems mentioned above and provide novel thermoplastic resin composition pellet which does not require addition of a foaming agent and can be foamed and molded without any modification at a production site; and a method for producing these thermoplastic resin composition pellet stably with favorable productivity.

### Solution to Problem

As a result of diligent research carried out in order to solve the problems mentioned above, the inventors of the present invention have found that these problems can be solved by thermoplastic resin composition pellet obtained by blending heat-expandable microsphere, which have a maximum expansion temperature that falls within a specific temperature range, as a foaming agent, with a polybutylene terephthalate resin having a specific intrinsic viscosity and a polystyrene or rubber-reinforced polystyrene resin, and thereby completed the present invention.

The present invention relates to the following thermoplastic resin composition pellet and a method for producing same.

[1] A thermoplastic resin composition pellet comprising,
30 to 100 parts by mass of a polybutylene terephthalate resin (A) that has an intrinsic viscosity of 0.3 to 1.3 dl/g,
0 to 70 parts by mass of a polystyrene or a rubber-reinforced polystyrene resin (B),
and further comprising 0.5 to 20 parts by mass of a heat-expandable microsphere (C) relative to 100 parts by mass of the total (A) and (B),
wherein a maximum expansion temperature of the heat-expandable microsphere (C), is in a range of 250 to 320° C., and an average particle diameter of the heat-expandable microsphere (C) is in a range of 10 to 50 μm.

[2] The pellet of [1], which is a material for injection molding.

[3] The pellet of [1] or [2], further comprising an inorganic filler (D) in a range of 10 to 100 parts by mass relative to 100 parts by mass of the total (A) and (B).

[4] The pellet of any of [1] to [3], wherein the melt viscosity of the polystyrene or rubber-reinforced polystyrene resin (B) at 250° C. and 912 sec⁻¹ is in the range 80 to 500 Pa·s.

[5] The pellet of [3], wherein the inorganic filler (D) is a fibrous filler.

[6] The pellet of any one of [1] to [5], further comprising a polycarbonate resin as a compatibilizer (E) in a range of 0 to 30 parts by mass relative to 100 parts by mass of the total (A) and (B).

[7] A molded article obtained by foam molding the pellet of any one of [1] to [6].

[8] The molded article of [7], wherein a decrease rate of a specific gravity of a foam molded article relative to a specific gravity of an unfoamed molded article is 15% or more.

[9] The molded article of [7] or [8], which is a molded component installed to a motor vehicle.

[10] A method for producing a thermoplastic resin composition pellet by using an extruder, wherein the thermoplastic resin composition pellet comprising,
30 to 100 parts by mass of a polybutylene terephthalate resin (A) that has an intrinsic viscosity of 0.3 to 1.3 dl/g,
0 to 70 parts by mass of a polystyrene or a rubber-reinforced polystyrene resin (B),
and further comprising 0.5 to 20 parts by mass of a heat-expandable microsphere (C) relative to 100 parts by mass of the total (A) and (B),
the method comprising mixing and melting the polybutylene terephthalate resin (A) and the polystyrene or rubber-reinforced polystyrene resin (B), and then adding the heat-expandable microsphere (C).

[11] A method for producing a thermoplastic resin composition pellet by using an extruder, wherein the thermoplastic resin composition pellet comprises,
30 to 100 parts by mass of a polybutylene terephthalate resin (A) that has an intrinsic viscosity of 0.3 to 1.3 dl/g,
0 to 70 parts by mass of a polystyrene or a rubber-reinforced polystyrene resin (B),
and further comprising 0.5 to 20 parts by mass of a heat-expandable microsphere (C) relative to 100 parts by mass of the total (A) and (B),
the method comprising including a step for melt kneading a master batch including the heat-expandable microsphere (C) and a thermoplastic resin with the polybutylene terephthalate resin (A) and the polystyrene or rubber-reinforced polystyrene resin (B).

[12] The method for producing thermoplastic resin composition pellet of [10] or [11], further comprising blending an inorganic filler (D) in a range of 10 to 100 parts by mass relative to 100 parts by mass of the total (A) and (B).

[13] The production method of [12], further comprising side-feeding the inorganic filler (D), mixing, and then blending the heat-expandable microsphere (C) or a master batch including the heat-expandable microsphere (C) and a thermoplastic resin.

[14] The production method of [12] or [13], wherein the inorganic filler (D) is a fibrous filler.

[15] The production method of any of [10] to [14], further comprising incorporating a compatibilizer (E) in a range of 5 to 50 parts by mass relative to 100 parts by mass of the total (A) and (B).

[16] The production method of any of [10] to [15], wherein a maximum expansion temperature of the heat-expandable microsphere (C) is in a range of 250 to 320° C.

[17] The production method of any of [10] to [16], wherein a resin temperature immediately after leaving the extruder in a range of 200 to 275° C.

[18] The production method of any of [10] to [17], wherein a distance S from a tip of the extruder to a position, at which the heat-expandable microsphere (C) is fed, relative to an overall length L of the extruder is such that a value of S/L is in a range of 0.05 to 0.5.

[19] The production method of any of [10] to [18], wherein a melt viscosity of the polystyrene or rubber-reinforced polystyrene resin (B) at 250° C. and 912 sec-1 is in a range of 80 to 500 Pa·s.

### Advantageous Effects of Invention

The thermoplastic resin composition pellet of the present invention enables favorable foam molding on a molding company without the need to use a foaming agent at the time of molding. In addition, a foam molded article obtained by foam molding the pellet achieves a significant weight reduction effect, has a favorable shape and appearance, does not suffer from sinks or warping, and exhibits excellent heat resistance.

In addition, the polybutylene terephthalate resin forms a sea (matrix) in a sea-island structure or a sea in a co-continuous structure, and a polystyrene resin or rubber-reinforced polystyrene resin having a high melt viscosity tends to form islands, and as a result, it is possible to achieve high heat resistance, low warpage, excellent appearance, and excellent mechanical strength and chemical resistance.

In addition, by further incorporating a compatibilizer, it is possible to further improve strength and appearance.

In addition, by further incorporating an inorganic filler, resin phases of the polybutylene terephthalate resin become continuous via the inorganic filler and tend to form a matrix (sea), meaning that the characteristic heat resistance is further improved, warpage is low, appearance is excellent, and mechanical strength and chemical resistance are also excellent. In the case of a reinforced system in which a reinforcing filler is blended, a hard reinforcing filler stimulates a foaming agent and readily causes foaming and foam rupture, and this is innovative considering that resin compositions containing foaming agents have not been easy to realize in reinforced systems.

### DESCRIPTION OF EMBODIMENTS

The thermoplastic resin composition pellet of the present invention contains 30 to 100 parts by mass of a polybutylene terephthalate resin (A) that has an intrinsic viscosity of 0.3 to 1.3 dl/g and 0 to 70 parts by mass of a polystyrene or a rubber-reinforced polystyrene resin (B), and also contains 0.5 to 20 parts by mass of heat-expandable microsphere (C), which have a maximum expansion temperature within a range of 250 to 320° C. and an average particle diameter within a range of 10 to 50 μm, relative to 100 parts by mass of the total (A) and (B).

The method for producing thermoplastic resin composition pellet of a first method of the present invention is the method for producing resin composition containing 30 to 100 parts by mass of a polybutylene terephthalate resin (A) having an intrinsic viscosity of 0.3 to 1.3 dl/g and 0 to 70 parts by mass of a polystyrene or a rubber-reinforced polystyrene resin (B), and further containing heat-expandable microsphere (C) at a quantity of 0.5 to 20 parts by mass relative to 100 parts by mass of the total (A) and (B), by using an extruder, the method comprising mixing and melting the polybutylene terephthalate resin (A) and the polystyrene or rubber-reinforced polystyrene resin (B), and then adding the heat-expandable microsphere (C).

The second method of the present invention is the method for producing resin composition containing 30 to 100 parts by mass of a polybutylene terephthalate resin (A) having an intrinsic viscosity of 0.3 to 1.3 dl/g and 0 to 70 parts by mass of a polystyrene or a rubber-reinforced polystyrene resin (B), and further containing heat-expandable microsphere (C) at a quantity of 0.5 to 20 parts by mass relative to 100 parts by mass of the total (A) and (B), by using an extruder, the method comprising a step for melt kneading a master batch comprising the heat-expandable microsphere (C) and a thermoplastic resin with the polybutylene terephthalate resin (A) and the polystyrene or rubber-reinforced polystyrene resin (B).

Embodiments of the present invention will now be explained in detail. Explanations given below are based on embodiments and specific examples, but it should be understood that the present invention is not limited to such embodiments or specific examples.

Moreover, use of the wording “xxx to yyy” in the present specification means that numerical values mentioned before and after the “-” include the lower limit and upper limit thereof.

### [(A) Polybutylene Terephthalate Resin]

A polybutylene terephthalate resin (A) having an intrinsic viscosity (IV) of 0.3 to 1.3 dl/g is used in the present invention. If a resin having an IV of not more than 0.3 dl/g is used, the heat resistance of the polybutylene terephthalate resin is not exhibited, and mechanical strength tends to be low. If a resin having an IV of more than 1.3 dl/g is used, obtained resin composition pellet tends to have poor fluidity and poor moldability, and the heat-expandable microsphere tends to rupture as a result of shear heat generation, meaning that sinks tend to occur when the pellet is foamed and molded, and a favorable foam molded article is unlikely to be obtained.

The IV is preferably 0.4 dl/g or more, more preferably 0.5 dl/g or more, and further preferably 0.55 dl/g or more, such as 0.6 dl/g or more, and is preferably 1.2 dl/g or less, such as 1.1 dl/g or less, 1.0 dl/g or less, 0.9 dl/g or less or 0.8 dl/g or less, and is particularly preferably 0.75 dl/g or less.

Moreover, the intrinsic viscosity of the polybutylene terephthalate resin (A) in the present invention is a value measured at 30° C. in a mixed solvent comprising tetrachloroethane and phenol at a mass ratio of 1:1.

The polybutylene terephthalate resin (A) is a polyester resin having a structure in which terephthalic acid units and 1,4-butane diol units are bonded by ester bonds, and includes not only polybutylene terephthalate resin (homopolymers), but also polybutylene terephthalate copolymer that contains other copolymer components in addition to terephthalic acid units and 1,4-butane diol units, and mixtures of homopolymer and such copolymer.

The polybutylene terephthalate resin (A) may contain dicarboxylic acid units other than terephthalic acid, and specific examples of these other dicarboxylic acid units include aromatic dicarboxylic acid such as isophthalic acid, orthophthalic acid, 1,5-naphthalenedicarboxylic acid, 2,5-naphthalenedicarboxylic acid, 2,6-naphthalenedicarboxylic acid, biphenyl-2,2′-dicarboxylic acid, biphenyl-3,3′-dicarboxylic acid, biphenyl-4,4′-dicarboxylic acid, bis(4,4′-carboxyphenyl)methane, anthracenedicarboxylic acid and 4,4′-diphenyl ether dicarboxylic acid; alicyclic dicarboxylic acid such as 1,4-cyclohexanedicarboxylic acid and 4,4′-dicyclohexyldicarboxylic acid; and aliphatic dicarboxylic acid such as adipic acid, sebacic acid, azelaic acid and dimer acid.

In cases where the polybutylene terephthalate resin (A) contains diol units other than 1,4-butane diol, specific examples of these other diol units include aliphatic and alicyclic diol having 2 to 20 carbon atoms and bisphenol derivatives. Specific examples thereof include ethylene glycol, propylene glycol, 1,5-pentane diol, 1,6-hexane diol, neopentyl glycol, decamethylene glycol, cyclohexane dimethanol, 4,4′-dicyclohexylhydroxymethane, 4,4′-dicyclohexylhydroxypropane and ethylene oxide-added diols of bisphenol A. In addition to difunctional monomers such as those mentioned above, it is possible to additionally use a small quantity of a trifunctional monomer, such as trimellitic acid, trimesic acid, pyromellitic acid, pentaerythritol or trimethylolpropane in order to introduce a branched structure, or a monofunctional compound such as a fatty acid in order to adjust molecular weight.

The polybutylene terephthalate resin (A) is preferably a polybutylene terephthalate homopolymer obtained through polycondensation of terephthalic acid and 1,4-butane diol, as mentioned above, but may also be a polybutylene terephthalate copolymer containing one or more dicarboxylic acids other than terephthalic acid as carboxylic acid units and/or one or more diols other than 1,4-butane diol as diol units as long as the crystallinity of the polybutylene terephthalate resin (A) is not impaired, and in cases where the polybutylene terephthalate resin (A) is a polybutylene terephthalate resin modified by means of copolymerization, examples of preferred specific copolymer includes polyester-ether resin obtained by copolymerizing with polyalkylene glycol, and especially polytetramethylene glycol, dimer acid-copolymerized polybutylene terephthalate resin and isophthalic acid-copolymerized polybutylene terephthalate resin.

Moreover, in the case of these copolymers, the copolymerization amount is preferably not less than 1 mol % and less than 50 mol % of all segments in the polybutylene terephthalate resin. Within this range, the copolymerization amount is preferably not less than 2 mol % and less than 50 mol %, more preferably 3 to 40 mol %, and particularly preferably 5 to 20 mol %. Such a copolymerization proportion is preferred from the perspectives of improving fluidity and ductility.

The polybutylene terephthalate resin (A) preferably has a terminal carboxyl group amount of 0.1 to 30 eq/ton. If this amount exceeds 30 eq/ton, hydrolysis resistance and alkali resistance deteriorate, and gas tends to be generated when the resin composition pellet is foam molded. The terminal carboxyl group amount is more preferably 3 eq/ton or more, and further preferably 5 eq/ton or more, and is more preferably 25 eq/ton or less, and further preferably 20 eq/ton or less.

Moreover, the amount of terminal carboxyl groups in the polybutylene terephthalate resin (A) is a value measured by dissolving 0.5 g of polybutylene terephthalate resin in 25 mL of benzyl alcohol, and titrating using a 0.01 mol/L benzyl alcohol solution of sodium hydroxide. A method for adjusting the amount of terminal carboxyl groups should be a conventional well-known method, such as a method comprising adjusting polymerization conditions such as the charging ratios of raw materials when polymerizing, the polymerization temperature or the pressure reduction method, or a method comprising reacting a terminal-blocking agent.

The polybutylene terephthalate resin (A) can be produced by subjecting a dicarboxylic acid component containing terephthalic acid as a primary component, or an ester derivative thereof, and a diol component containing 1,4-butane diol as a primary component to batch type or continuous melt polymerization. In addition, it is also possible to increase the degree of polymerization (or molecular weight) to a desired value by producing a low molecular weight polybutylene terephthalate resin by means of melt polymerization and then carrying out solid state polymerization in a nitrogen stream or under reduced pressure.

The polybutylene terephthalate resin (A) is preferably obtained using a production method comprising subjecting a dicarboxylic acid component containing terephthalic acid as a primary component and a diol component containing 1,4-butane diol as a primary component to continuous melt polycondensation.

A catalyst used when carrying out an esterification reaction may be a catalyst that was known in the past, for example a titanium compound, a tin compound, a magnesium compound or a calcium compound. Of these, titanium compounds are particularly preferred. Specific examples of titanium compounds used as esterification catalysts include titanium alcoholate, such as tetramethyl titanate, tetraisopropyl titanate and tetrabutyl titanate; and titanium phenolate such as tetraphenyl titanate.

### [(B) Polystyrene or Rubber-Reinforced Polystyrene Resin]

The present invention contains a polystyrene or rubber-reinforced polystyrene resin (B) at a quantity of 0 to 70 parts by mass relative to 100 parts by mass of the total of polybutylene terephthalate (A) and polystyrene or rubber-reinforced polystyrene resin (B).

The polystyrene or rubber-reinforced polystyrene resin (B) is preferably amorphous. Here, the term amorphous means that when a sample is measured using a differential scanning calorimeter (DSC) or the like, no clear melting point or melting peak is detected. Conversely, the term crystalline means that a crystal structure in which molecules are arranged in an ordered manner tends to be formed, and a melting point and a melting peak are present in measurements carried out using a differential scanning calorimeter (DSC) or the like. Syndiotactic polystyrene or the like, in which benzene rings are alternately arranged in an ordered manner on a polymer main chain, is crystalline and is preferably excluded as the polystyrene or rubber-reinforced polystyrene resin (B).

The polystyrene resin may be a homopolymer of styrene or a copolymer obtained by copolymerizing another aromatic vinyl monomer, such as α-methylstyrene, paramethylstyrene, vinyltoluene or vinylxylene, at a quantity of, for example, 50 mass % or less.

The rubber-reinforced polystyrene resin is preferably obtained by copolymerizing or blending a butadiene rubber component, and the amount of the butadiene rubber component is generally not less than 1 mass % and less than 50 mass %, preferably 3 to 40 mass %, more preferably 5 to 30 mass %, and further preferably 5 to 20 mass %. It is particularly preferable for the rubber-reinforced polystyrene resin to be a high impact polystyrene (HIPS).

In the present invention, it is preferable to use a resin having a melt viscosity of 80 to 500 Pa·s, as measured at 250° C. and 912 sec⁻¹, as the polystyrene or rubber-reinforced polystyrene resin (B). The polystyrene or rubber-reinforced polystyrene resin (B) having such a melt viscosity (η_{B}) is contained at a quantity such that relative to 100 parts by mass of the total (A) and (B), the content of the polybutylene terephthalate resin (A) is 30 to 100 parts by mass and the content of the polystyrene or rubber-reinforced polystyrene resin (B) is 0 to 70 parts by mass, and by further incorporating the heat-expandable microsphere (C), the polybutylene terephthalate resin (A) becomes dominant in terms of physical properties, meaning that it is possible to achieve high heat resistance, low warpage and low specific gravity. If the melt viscosity is 80 Pa·s or more, heat resistance tends to be further improved. In addition, if the melt viscosity is 500 Pa·s or less, excellent production stability and fluidity are achieved, and foam molding properties can be further improved.

The content of the polystyrene or rubber-reinforced polystyrene resin (B) is 0 to 70 parts by mass relative to 100 parts by mass of the total (A) and (B), but is more preferably 10 parts by mass or more, further preferably 20 parts by mass or more, such as 30 parts by mass or more, 40 parts by mass or more, 50 parts by mass or more, or 55 parts by mass or more, and is more preferably 65 parts by mass or less.

The melt viscosity (η_{B}) of the polystyrene or rubber-reinforced polystyrene resin (B) is more preferably 90 Pa·s or more, and within this range is particularly preferably 100 Pa·s or more, 110 Pa·s or more, or 120 Pa·s or more. In addition, the upper limit for this melt viscosity is more preferably 400 Pa·s or less, and further preferably 300 Pa·s or less, and within this range is particularly preferably 250 Pa·s or less, 220 Pa·s or less, 200 Pa·s or less, 180 Pa·s or less, or 160 Pa·s or less.

Moreover, the melt viscosity of the polystyrene or rubber-reinforced polystyrene resin (B) can be measured in accordance with ISO 11443 using a capillary rheometer and a slit die rheometer. More specifically, melt viscosity can be calculated from the stress when a piston is pushed at a piston speed of 75 mm/min into a furnace body having an internal diameter of 9.5 mm and heated to a temperature of 250° C. using an orifice having a capillary diameter of 1 mm and a capillary length of 30 mm.

[(C) Heat-Expandable Microsphere]

The present invention contains heat-expandable microsphere (C) having a maximum expansion temperature that falls within the range 250 to 320° C.

The heat-expandable microsphere (C) is an ultrafine spherical foaming agent that can be foamed by being heated, and microspherical particles such as microcapsules, in which a substance that can be easily expanded by being heated is encapsulated inside an elastic shell, can be used as the heat-expandable microsphere. This type of heat-expandable microsphere can be produced using any suitable method, such as a coacervation method or an interfacial polymerization method.

Examples of substances that can be easily expanded by being heated include: hydrocarbons having 3 to 13 carbon atoms, such as propane, (iso)butane, (iso)pentane, (iso)hexane, (iso)heptane, (iso)octane, (iso)nonane, (iso)decane, (iso)undecane, (iso)dodecane and (iso)tridecane; hydrocarbons having more than 13 but not more than 20 carbon atoms, such as (iso)hexadecane and (iso)eicosane; hydrocarbons such as petroleum fractions, such as pseudocumene, petroleum ether, and normal paraffins and iso-paraffins having an initial boiling point of 150 to 260° C. and/or a distillation range of 70 to 360° C.; halogenated products of these; fluorine-containing compounds such as hydrofluoro ether; tetraalkylsilane; and compounds that generate gas upon thermal decomposition when heated. It is possible to use one of these thermally expandable substances, or a combination of two or more types thereof. Among these thermally expandable substances, straight chain, branched and alicyclic hydrocarbon are preferred, and aliphatic hydrocarbon is more preferred.

Examples of substances that constitute the shell mentioned above include polymers constituted from: nitrile monomers such as acrylonitrile, methacrylonitrile, α-chloroacrylonitrile, α-ethoxyacrylonitrile and fumaronitrile; carboxylic acid monomers such as acrylic acid, methacrylic acid, itaconic acid, maleic acid, fumaric acid and citraconic acid; vinylidene chloride; vinyl acetate; (meth)acrylic acid esters such as methyl (meth)acrylate, ethyl (meth)acrylate, n-butyl (meth)acrylate, isobutyl (meth)acrylate, t-butyl (meth)acrylate, isobornyl (meth)acrylate, cyclohexyl (meth)acrylate, benzyl (meth)acrylate and β-carboxyethyl acrylate; styrene monomers such as styrene, α-methylstyrene and chlorostyrene; and amide monomers such as acrylamide, substituted acrylamide, methacrylamide and substituted methacrylamide. Polymers constituted from these monomers can be homopolymers or copolymers. Examples of copolymers include vinylidene chloride-methyl methacrylate-acrylonitrile copolymer, methyl methacrylate-acrylonitrile-methacrylonitrile copolymer, methyl methacrylate-acrylonitrile copolymer, and acrylonitrile-methacrylonitrile-itaconic acid copolymer.

The average particle diameter of the heat-expandable microsphere (C) preferably falls within the range 10 to 50 μm. If the average particle diameter of the heat-expandable microsphere falls within the range mentioned above, a molded body that is lightweight and has a favorable appearance can be easily obtained. The upper limit of the average particle diameter of the heat-expandable microsphere is more preferably 40 μm, and further preferably 30 μm. Meanwhile, the lower limit of the average particle diameter of the heat-expandable microsphere is more preferably 15 μm.

Average particle diameter measurements are preferably carried out using the specific method described below.

Using a Microtrac particle size distribution measurement apparatus (model no. 9320-HRA) as a measurement apparatus, a D50 value in volume-based measurements is taken to be the average particle diameter.

The expansion initiation temperature of the heat-expandable microsphere (C) is preferably in the range 215 to 270° C. A preferred specific measurement method is as described below. The expansion initiation temperature is more preferably 220° C. or higher, further preferably 225° C. or higher, further preferably 230° C. or higher, and further preferably 235° C. or higher, and within this range is preferably 240° C. higher, 245° C. or higher, and especially 250° C. or higher. An expansion initiation temperature that falls within the range mentioned above is suitable for producing a foam molded product using the obtained resin composition pellet, and said foam molded product achieves a significant weight reduction effect as a result of foaming, and this is preferred from the perspective of a foam molded article exhibiting an excellent appearance and shape.

The heat-expandable microsphere (C) has a maximum expansion temperature that falls within the range 250 to 320° C. The maximum expansion temperature means the temperature at which expansion of the heat-expandable microsphere is at a maximum, and a preferred example of a specific measurement method is as described below. The maximum expansion temperature is preferably 255° C. or more, and more preferably 260° C. or more, and is preferably 310° C. or lower, and more preferably 300° C. or lower, and within this range is preferably 290° C. or lower, 285° C. or lower, and especially 280° C. or lower. A maximum expansion temperature that falls within the range mentioned above is suitable for producing a foam molded product using the resin composition pellet, and said foam molded product achieves a significant weight reduction effect as a result of foaming, and this leads to a foam molded article that exhibits an excellent appearance and shape.

The expansion initiation temperature and maximum expansion temperature are preferably measured using the specific method described below.

Using a dynamic viscoelasticity measurement apparatus (DMA) as a measurement apparatus, 0.5 mg of a sample is placed in an aluminum cup having a diameter of 6.0 mm and a depth of 4.8 mm, an aluminum lid (diameter 5.6 mm, thickness 0.1 mm) is placed on the sample, a force of 0.01 N is applied to the sample from above using a compressing element, and the height of the sample in this state is measured. The sample is heated from 20° C. to 300° C. at a temperature increase rate of 10° C./min while a force of 0.01 N is applied using the compressing element, the amount of displacement is measured in the vertical direction of the compressing element, the displacement initiation temperature in the forward direction is taken to be the expansion initiation temperature of the heat-expandable microsphere, and the temperature at which the maximum amount of displacement is shown is taken to be the maximum expansion temperature.

The heat-expandable microsphere (C) may be a commercially available product. Specific examples of commercially available heat-expandable microsphere include “Matsumoto Microspheres” produced by Matsumoto Yushi-Seiyaku Co., Ltd., “Expancel” produced by Japan Fillite Co., Ltd., “Daifoam” produced by Kureha Chemical Industry Co., Ltd., and “Advancell” produced by Sekisui Chemical Co., Ltd.

The content of the heat-expandable microsphere (C) is 0.5 to 20 parts by mass relative to 100 parts by mass of the total of the polybutylene terephthalate resin (A) and the polystyrene or rubber-reinforced polystyrene resin (B), and is preferably 1 part by mass or more, and more preferably 1.5 parts by mass or more, and within this range is preferably 2 parts by mass or more, 2.5 parts by mass or more or 3 parts by mass or more, and is preferably 17 parts by mass or less, and more preferably 15 parts by mass or less, and within this range is preferably 13 parts by mass or less, 12 parts by mass or less, 11 parts by mass or less, 10 parts by mass or less, 9 parts by mass or less, and especially 8 parts by mass or less.

The heat-expandable microsphere (C) may be in the form of a master batch in which a thermoplastic resin is a base resin, but the content mentioned above does not include the thermoplastic resin that serves as a base in the case of a master batch, and is the content of the heat-expandable microsphere (C) per se, and is the content of the heat-expandable microsphere in isolation in the resin composition pellet.

In the present invention, the heat-expandable microsphere (C) may be formed as a master batch in which a thermoplastic resin is a base resin.

The base resin used in the master batch should be one having favorable compatibility with the polybutylene terephthalate resin (A), examples of which include olefinic resin such as ethylene-(meth)acrylic acid copolymer, ethylene-(meth)acrylic acid ester copolymer, ethylene-vinyl alcohol copolymer, ethylene-vinyl acetate copolymer, polyethylene, polypropylene, polybutene, polyisobutylene, polystyrene and polyterpene; styrenic copolymer such as styrene-acrylonitrile copolymer and styrene-butadiene-acrylonitrile copolymer; thermoplastic resin elastomers such as polyester elastomer, styrenic elastomer and olefinic elastomer; and polyester resin such as isophthalic acid-copolymerized polybutylene terephthalate. Moreover, the master batch is preferably prepared at a temperature that is not higher than the expansion initiation temperature of the heat-expandable microsphere.

The concentration of the heat-expandable microsphere (C) in the master batch is not particularly limited, but is preferably 20 mass % or more, and more preferably 25 mass % or more, and within this range is preferably 30 mass % or more, 35 mass % or more, and especially 40 mass % or more, and is preferably 80 mass % or less, and more preferably 75 mass % or less, and within this range is preferably 70 mass % or less, 65 mass % or less, and especially 60 mass % or less. If this concentration is too low or too high, the foaming effect tends to deteriorate when the obtained thermoplastic resin composition pellet is foamed and molded.

### [(D) Inorganic Filler]

The present invention preferably further contains an inorganic filler (D).

In the case of a reinforced system in which the polybutylene terephthalate resin is mixed with an inorganic filler in order to improve mechanical strength, heat resistance, and so on, it is thought that foaming and foam rupture tend to occur as a result of damage and loss when the heat-expandable microsphere (C) are melt kneaded because inorganic fillers do not soften even at high temperatures, exhibit high rigidity and are often hard sharp materials, and there are no known examples in which reinforced foaming resin pellet has been realized, but such problems can be solved by the production method of the present invention, as shown in the examples section.

Examples of the inorganic filler (D) include fibrous fillers and others, but in cases where the inorganic filler is fibrous, preferred examples thereof include inorganic fibrous fillers such as glass fiber, carbon fiber, silica-alumina fiber, zirconia fiber, boron fiber, boron nitride fiber, silicon nitride-potassium titanate fiber, metal fiber and wollastonite fiber, but carbon fiber and glass fiber are particularly preferred.

Carbon fiber which has a preferred average fiber diameter of 1 to 25 μm, and especially 8 to 15 μm, and an average fiber length in the long axis direction of 1 to 10 mm, and especially 2 to 5 mm can be advantageously used as carbon fiber. If the average fiber diameter is less than 1 μm, bulk density is low, uniform dispersibility deteriorates, and molding processing properties tend to be impaired. In addition, if the average fiber diameter exceeds 25 μm, the appearance of a molded article deteriorates and a reinforcing effect tends to be insufficient. In addition, a reinforcing effect is insufficient if the average fiber length is too short, and workability and molding processing properties at the time of kneading are impaired if the average fiber length is too long.

Regardless of the form of glass fiber at the time of blending, such as chopped strand, roving glass or a master batch of a thermoplastic resin and glass fiber, any type of well-known glass fibers can be used as glass fiber, such as A-glass, E-glass, and zirconia component-containing alkali-resistant glass compositions, as long as these are glass fibers commonly used in polybutylene terephthalate resin. Of these, the glass fiber are preferably an alkali-free glass (E-glass) from the perspective of improving the thermal stability of the thermoplastic resin composition pellet and a foam molded article thereof.

The glass fiber or carbon fiber may be treated with a sizing agent or a surface treatment agent. In addition to untreated glass fiber and carbon fiber, it is possible to surface treat glass fiber or carbon fiber through addition of a sizing agent or a surface treatment agent when the thermoplastic resin composition pellet is produced.

Examples of sizing agents include emulsion of resins such as vinyl acetate resin, ethylene/vinyl acetate copolymer, acrylic resin, epoxy resin, polyurethane resin and polyester resin.

Examples of surface treatment agents, aminosilane compounds such as γ-aminopropyltriethoxysilane, γ-aminopropyltrimethoxysilane and γ-(2-aminoethyl)aminopropyltrimethoxysilane, chlorosilane compounds such as vinyltrichlorosilane and methylvinyldichlorosilane, alkoxysilane compounds such as vinyltrimethoxysilane, vinyltriethoxysilane, vinyltriacetoxysilane and γ-methacryloxypropyltrimethoxysilane, epoxysilane compounds such as β-(3,4-epoxycyclohexyl)ethyltrimethoxysilane and γ-glycidoxypropyltrimethoxysilane, acrylic compound, isocyanate compound, titanate compound and epoxy compound.

It is possible to use a combination of two or more of these sizing agents and surface treatment agents, and the usage quantity (coating weight) thereof is generally 10 mass % or less, and preferably 0.05 to 5 mass %, relative to the mass of the glass fiber or carbon fiber. Setting this coating weight to be 10 mass % or less achieves a necessary and satisfactory effect, and is therefore economically advantageous.

In addition to fibrous filler, the inorganic filler (D) preferably contains a plate-like, granular or amorphous inorganic filler. Examples of plate-like inorganic fillers include talc, mica, wollastonite, white clay, calcium carbonate and glass flake, with talc, mica, wollastonite, white clay, calcium carbonate, and the like, being preferred.

Examples of other types of granular and amorphous inorganic fillers include ceramic bead, asbestos, clay, zeolite, potassium titanate, barium sulfate, titanium oxide, silicon oxide, aluminum oxide and magnesium hydroxide.

The content of the inorganic filler (D) is preferably 10 to 100 parts by mass, and more preferably 10 to 90 parts by mass, and within this range is preferably 10 to 80 parts by mass, particularly preferably 10 to 70 parts by mass, and most preferably 10 to 60 parts by mass, relative to 100 parts by mass of the total of polybutylene terephthalate resin (A) and polystyrene or rubber-reinforced polystyrene resin (B). If this content falls within such a range, a high degree of heat resistance can be achieved and it is possible to enhance the strength and shrinkage reduction effect of a foam molded body obtained from the resin composition pellet, and the surface appearance of a molded body may deteriorate if this content exceeds 100 parts by mass, and a strength improvement effect tends to be slight if this content is less than 10 parts by mass.

In cases where the inorganic filler (D) is contained, and especially in cases where a fibrous inorganic filler is contained, it is preferable to side feed the inorganic filler when production is carried out using an extruder. For example, it is preferable to side feed the inorganic filler (D) after the polybutylene terephthalate resin (A) and the polystyrene or rubber-reinforced polystyrene (B) have been melted, and then side feed the heat-expandable microsphere (C) or master batch.

### [(E) Compatibilizer]

The present invention preferably further contains a compatibilizer (E). Incorporating the compatibilizer (E) facilitates compatibilization of the polybutylene terephthalate resin (A) and the polystyrene or rubber-reinforced polystyrene resin (B) with the heat-expandable microsphere (C) or the thermoplastic resin in the master batch, meaning that the dispersed particle diameter of the components decreases, interfacial strength increases, and excellent mechanical strength and appearance are readily achieved.

The compatibilizer (E) is not particularly limited as long as this can achieve a compatibilization function with the resins mentioned above, but is preferably a polymer compound-containing compatibilizer from the perspective of heat resistance.

It is particularly preferable for the compatibilizer (E) to be a polycarbonate resin or a styrene-maleic acid copolymer.

The polycarbonate resin is an optionally branched thermoplastic polymer or copolymer obtained by reacting a dihydroxy compound or a dihydroxy compound and a small quantity of a polyhydroxy compound with phosgene or a carbonic acid diester. The method for producing the polycarbonate resin is not particularly limited, and it is possible to use a conventional well known phosgene method (an interfacial polymerization method) or melt process (a transesterification process).

The dihydroxy compound raw material is preferably an aromatic dihydroxy compound that contains substantially no bromine atoms. Specific examples thereof include 2,2-bis(4-hydroxyphenyl)propane (that is, bisphenol A), tetramethylbisphenol A, bis(4-hydroxyphenyl)-p-diisopropylbenzene, hydroquinone, resorcinol and 4,4-dihydroxydiphenyl, and bisphenol A is preferred. In addition, it is possible to use a compound in which one or more tetraalkyl phosphonium sulfonates are bonded to an aromatic dihydroxy compound mentioned above.

Among those mentioned above, the polycarbonate resin is preferably an aromatic polycarbonate resin derived from 2,2-bis(4-hydroxyphenyl)propane or an aromatic polycarbonate copolymer derived from 2,2-bis(4-hydroxyphenyl)propane and another aromatic dihydroxy compound. In addition, the polycarbonate resin may also be a copolymer comprising mainly an aromatic polycarbonate resin, such as a copolymer of an aromatic polycarbonate and a polymer or oligomer having a siloxane structure. Furthermore, it is possible to use a mixture of two or more the polycarbonate resins mentioned above.

A monovalent aromatic hydroxy compound should be used in order to adjust the molecular weight of the polycarbonate resin, and examples of such compounds include m- and p-methylphenol, m- and p-propylphenol, p-tert-butylphenol and p-long chain alkyl-substituted phenol compounds.

The viscosity average molecular weight (Mv) of the polycarbonate resin is preferably 15,000 or more, and if a polycarbonate resin having an Mv value of not more than 15,000 is used, an obtained resin composition tends to have low mechanical strength, such as impact resistance. In addition, the Mv value is preferably 60,000 or less, and more preferably 40,000 or less, and within this range is further preferably 35,000 or less. If a polycarbonate resin having a viscosity average molecular weight of more than 60,000 is used, the fluidity and moldability of the resin composition may deteriorate.

In the present invention, the viscosity average molecular weight (Mv) of the polycarbonate resin is a value that is obtained by determining the intrinsic viscosity ([η]) by measuring the viscosity of a methylene chloride solution of the polycarbonate resin at a temperature of 25° C. using a Ubbelohde type viscometer, and then calculating the viscosity average molecular weight from the Schnell viscosity equation below.

$$[ η ] = 1.23 \times 1 {0}^{- 4} M {v}^{0.83}$$

The method for producing the polycarbonate resin is not particularly limited, and it is possible to use a polycarbonate resin produced using the phosgene method (an interfacial polymerization method) or a melt process (a transesterification method). In addition, a polycarbonate resin obtained by subjecting a polycarbonate resin produced by means of a melt process to a post treatment for adjusting the amount of terminal hydroxyl groups is also preferred.

The styrene-maleic acid copolymer is preferably a styrene-maleic anhydride copolymer (an SMA resin), and is a copolymer of a styrene monomer and a maleic anhydride monomer, and can be produced using a known polymerization method such as radical polymerization.

The molecular weight and so on of the styrene-maleic acid copolymer is not particularly limited, but the mass average molecular weight thereof is preferably 10,000 or more and 500,000 or less, more preferably 40,000 or more and 400,000 or less, and further preferably 80,000 or more and 350,000 or less. Here, mass average molecular weight means mass average molecular weight in terms of polystyrene, as measured by gel permeation chromatography (GPC) using tetrahydrofuran as a solvent.

The styrene-maleic acid copolymer may be copolymerized with other monomer components as long as properties of the present invention are not impaired, and specific examples of other monomer components include aromatic vinyl monomers such as α-methylstyrene, vinyl cyanide monomers such as acrylonitrile, unsaturated carboxylic acid alkyl ester monomers such as methyl methacrylate and methyl acrylate, and maleimide monomers such as N-methylmaleimide, N-ethylmaleimide, N-cyclohexylmaleimide and N-phenylmaleimide, and it is possible to use one of these other monomer components, or two or more types thereof.

The content of the compatibilizer (E) is preferably 1 to 25 parts by mass, more preferably 3 to 20 parts by mass, and further preferably 3 to 18 parts by mass, relative to 100 parts by mass of total of polybutylene terephthalate resin (A) and polystyrene or rubber-reinforced polystyrene resin (B).

In a case where the compatibilizer (E) is a polycarbonate resin and/or a styrene-maleic acid copolymer, the content thereof is preferably a total of 0 to 30 parts by mass, more preferably 1 to 25 parts by mass, further preferably 3 to 20 parts by mass, and yet more preferably 3 to 18 parts by mass, relative to 100 parts by mass of the total polybutylene terephthalate resin (A) and polystyrene or rubber-reinforced polystyrene resin (B).

### [Stabilizer]

It is preferable for the present invention to contain a stabilizer from the perspectives of improving thermal stability and preventing a deterioration in mechanical strength, transparency and color hue. Phosphorus-containing stabilizers, sulfur-containing stabilizers and phenolic stabilizers are preferred as the stabilizer.

Examples of phosphorus-containing stabilizers include phosphorus acid, phosphoric acid, phosphorus acid ester (phosphite), trivalent phosphoric acid ester (phosphonite) and pentavalent phosphoric acid ester (phosphate), and of these, phosphite, phosphonite and phosphate are preferred.

A preferred organic phosphate compound is a compound represented by the general formula below:

(R¹O)₃₋ₙP(═O)OHₙ

In the formula, R¹ denotes an alkyl group or an aryl group, and multiple R¹ groups may be the same as, or different from, each other. n denotes an integer of 0 to 2.

A more preferred example of an organic phosphate compound is a long chain alkyl acid phosphate compound in which R¹ has 8 to 30 carbon atoms. Specific examples of alkyl groups having 8 to 30 carbon atoms include octyl group, 2-ethylhexyl group, isooctyl group, nonyl group, isononyl group, decyl group, isodecyl group, dodecyl group, tridecyl group, isotridecyl group, tetradecyl group, hexadecyl group, octadecyl group, eicosyl group and triacontyl group.

Examples of long chain alkyl acid phosphates include octyl acid phosphate, 2-ethylhexyl acid phosphate, decyl acid phosphate, lauryl acid phosphate, octadecyl acid phosphate, oleyl acid phosphate, behenyl acid phosphate, phenyl acid phosphate, nonylphenyl acid phosphate, cyclohexyl acid phosphate, phenoxyethyl acid phosphate, alkoxy polyethylene glycol acid phosphates, bisphenol A acid phosphate, dimethyl acid phosphate, diethyl acid phosphate, dipropyl acid phosphate, diisopropyl acid phosphate, dibutyl acid phosphate, dioctyl acid phosphate, di-2-ethylhexyl acid phosphate, dioctyl acid phosphate, dilauryl acid phosphate, distearyl acid phosphate, diphenyl acid phosphate and bisnonylphenyl acid phosphate. Of these, octadecyl acid phosphate is preferred, and this compound is commercially available as the product “Adekastab AX-71” produced by ADEKA.

A preferred organic phosphite compound is a compound represented by the general formula below:

R²O—P(OR³)(OR⁴)

In the formula, R², R³ and R⁴ are each a hydrogen atom, an alkyl group having 1 to 30 carbon atoms or an aryl group having 6 to 30 carbon atoms, and at least one of R², R³ and R⁴ is an aryl group having 6 to 30 carbon atoms.

Examples of organic phosphite compounds include triphenyl phosphite, tris(nonylphenyl) phosphite, dilauryl hydrogen phosphite, triethyl phosphite, tridecyl phosphite, tris(2-ethylhexyl) phosphite, tris(tridecyl) phosphite, tristearyl phosphite, diphenylmonodecyl phosphite, monophenyldidecyl phosphite, diphenylmono(tridecyl) phosphite, tetraphenyldipropylene glycol diphosphite, tetraphenyltetra(tridecyl)pentaerythritol tetraphosphite, hydrogenated bisphenol A phenyl phosphite polymers, diphenyl hydrogen phosphite, 4,4′-butylidene-bis(3-methyl-6-tert-butylphenyldi(tridecyl) phosphite), tetra(tridecyl)4,4′-isopropylidene diphenyl diphosphite, bis(tridecyl)pentaerythritol diphosphite, bis(nonylphenyl)pentaerythritol diphosphite, dilaurylpentaerythritol diphosphite, distearylpentaerythritol diphosphite, tris(4-tert-butylphenyl) phosphite, tris(2,4-di-tert-butylphenyl) phosphite, hydrogenated bisphenol A pentaerythritol phosphite polymers, bis(2,4-di-tert-butylphenyl)pentaerythritol diphosphite, bis(2,6-di-tert-butyl-4-methylphenyl)pentaerythritol diphosphite, 2,2′-methylene-bis(4,6-di-tert-butylphenyl)octyl phosphite and bis(2,4-dicumylphenyl)pentaerythritol diphosphite. Of these, bis(2,6-di-tert-butyl-4-methylphenyl)pentaerythritol diphosphite is preferred.

A preferred organic phosphonite compound is a compound represented by the general formula below:

R⁵—P(OR⁶)(OR⁷)

In the formula, R⁵, R⁶ and R⁷ are each a hydrogen atom, an alkyl group having 1 to 30 carbon atoms or an aryl group having 6 to 30 carbon atoms, and at least one of R⁵, R⁶ and R⁷ is an aryl group having 6 to 30 carbon atoms.

In addition, examples of organic phosphonite compounds include tetrakis(2,4-di-iso-propylphenyl)-4,4′-biphenylene diphosphonite, tetrakis(2,4-di-n-butylphenyl)-4,4′-biphenylene diphosphonite, tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, tetrakis(2,6-di-iso-propylphenyl)-4,4′-biphenylene diphosphonite, tetrakis(2,6-di-n-butylphenyl)-4,4′-biphenylene diphosphonite, tetrakis(2,6-di-tert-butylphenyl)-4,4′-biphenylene diphosphonite, tetrakis(2,6-di-tert-butylphenyl)-4,3′-biphenylene diphosphonite and tetrakis(2,6-di-tert-butylphenyl)-3,3′-biphenylene diphosphonite.

Any conventional well-known sulfur atom-containing compound can be used as the sulfur-containing stabilizer, and of these, a thioether compound is preferred. Specific examples thereof include didodecyl thiodipropionate, ditetradecyl thiodipropionate, dioctadecyl thiodipropionate, pentaerythritol tetrakis(3-dodecyl thiopropionate), thiobis(N-phenyl-β-naphthylamine), 2-mercaptobenzotriazole, 2-mercaptobenzimidazole, tetramethyl thiuram monosulfide, tetramethyl thiuram disulfide, nickel dibutyl dithiocarbamate, nickel isopropyl xanthate and trilauryl trithiophosphate. Of these, pentaerythritol tetrakis(3-dodecyl thiopropionate) is preferred.

Examples of phenol-containing stabilizers include pentaerythritol tetrakis(3-(3,5-di-t-butyl-4-hydroxyphenyl)propionate), octadecyl-3-(3,5-di-tert-butyl-4-hydroxyphenyl)propionate, thiodiethylene bis(3-(3,5-di-tert-butyl-4-hydroxyphenyl)propionate), and pentaerythritol tetrakis(3-(3,5-di-neopentyl-4-hydroxyphenyl)propionate). Of these, pentaerythritol tetrakis(3-(3,5-di-tert-butyl-4-hydroxyphenyl)propionate) and octadecyl-3-(3,5-di-tert-butyl-4-hydroxyphenyl)propionate are preferred.

It is possible to incorporate one stabilizer or an arbitrary combination of two or more types thereof combined at arbitrary proportions.

The content of the stabilizer is preferably 0.001 to 2 parts by mass relative to 100 parts by mass of the total polybutylene terephthalate resin (A) and polystyrene or rubber-reinforced polystyrene resin (B). If the content of the stabilizer is less than 0.001 parts by mass, an improvement in thermal stability can hardly be expected and a decrease in molecular weight and a deterioration in color hue readily occur when the resin composition pellet is foam molded, and if the content of the stabilizer exceeds 2 parts by mass, the quantity thereof becomes excessive, silvering occurs, and a deterioration in color hue readily occurs. The content of the stabilizer is more preferably 0.01 to 1.5 parts by mass, and further preferably 0.1 to 1 part by mass.

### [Mold-Release Agent]

The present invention preferably contains a mold-release agent. Known mold-release agents that are commonly used for polybutylene terephthalate resin may be used as the mold-release agent, but of these, it is preferable to use a polyolefin compound or a fatty acid ester compound from the perspective of achieving favorable alkali resistance, and a polyolefin compound is particularly preferred.

Examples of polyolefin compounds include compounds selected from among paraffin wax and polyethylene wax, and of these, compounds having weight average molecular weight of 700 to 10,000, and especially 900 to 8000, are preferred.

Examples of fatty acid ester compounds include fatty acid esters, such as esters of saturated or unsaturated monovalent or divalent aliphatic carboxylic acid, glycerin fatty acid ester and sorbitan fatty acid ester, and partially saponified products thereof. Of these, mono- and di-fatty acid esters constituted from fatty acid and alcohols having 11 to 28 carbon atoms, and preferably 17 to 21 carbon atoms, are preferred.

Examples of fatty acids include palmitic acid, stearic acid, caproic acid, capric acid, lauric acid, arachic acid, behenic acid, lignoceric acid, cerotic acid, melissic acid, tetratriacontanoic acid, montanic acid, adipic acid and azelaic acid. In addition, fatty acids may be alicyclic.

Saturated and unsaturated monohydric and polyhydric alcohols can be used as the alcohol. These alcohols may have substituent groups such as fluorine atom or aryl group. Of these, monohydric and polyhydric saturated alcohols having 30 or fewer carbon atoms are preferred, and aliphatic saturated monohydric and polyhydric alcohol having 30 or fewer carbon atoms are more preferred. Here, aliphatic compound also include alicyclic compound.

Specific examples of such alcohols include octanol, decanol, dodecanol, stearyl alcohol, behenyl alcohol, ethylene glycol, diethylene glycol, glycerin, pentaerythritol, 2,2-dihydroxyperfluoropropanol, neopentylene glycol, ditrimethylolpropane and dipentaerythritol.

Moreover, the ester compounds mentioned above may contain aliphatic carboxylic acids and/or alcohols as impurities, and may be a mixture of a plurality of compounds.

Specific examples of the fatty acid ester-containing compound include glycerol monostearate, glycerol monobehenate, glycerol dibehenate, glycerol-12-hydroxymonostearate, sorbitan monobehenate, pentaerythritol monostearate, pentaerythritol distearate, stearyl stearate and ethylene glycol montanic acid ester.

The content of the mold-release agent is preferably 0.1 to 3 parts by mass, more preferably 0.2 to 2.5 parts by mass, and further preferably 0.3 to 2 parts by mass, relative to 100 parts by mass of total of polybutylene terephthalate resin (A) and polystyrene or rubber-reinforced polystyrene resin (B). If this content is less than 0.1 parts by mass, surface properties tend to deteriorate as a result of release defects when the obtained resin composition pellet is foamed and molded, but if this content exceeds 3 parts by mass, kneading workability tends to deteriorate when the resin composition pellet is produced, and the surface of a molded article tends to be cloudy.

### [Carbon Black]

The present invention preferably contains carbon black.

The carbon black is not limited in terms of type, raw material or production method, and it is possible to use furnace black, channel black, acetylene black, ketjen black, or the like. The number average particle diameter of the carbon black is not particularly limited, but is preferably approximately 5 to 60 nm.

The carbon black is preferably blended as a master batch obtained in advance by mixing with thermoplastic resin, preferably polyalkylene terephthalate resin, and particularly preferably polybutylene terephthalate resin.

The content of carbon black is preferably 0.1 to 4 parts by mass, and more preferably 0.2 to 3 parts by mass, relative to 100 parts by mass of the total polybutylene terephthalate resin (A) and polystyrene or rubber-reinforced polystyrene resin (B). If this content is less than 0.1 parts by mass, a desired black color cannot be achieved and a weathering resistance improvement effect may not be sufficient, and if this content exceeds 4 parts by mass, mechanical properties tend to deteriorate.

### [Other Components]

The present invention can also contain thermoplastic resins other than those mentioned above as long as the advantageous effect of the present invention is not impaired. Specific examples of other thermoplastic resins include polyacetal resin, polyamide resin, polyphenylene oxide resin, polyphenylene sulfide resin, polysulfone resin, polyethersulfone resin, polyetherimide resin, polyether ketone resin and polyolefin resin.

However, in cases where another type of resin is contained, the content thereof is preferably 20 parts by mass or less, more preferably 10 parts by mass or less, further preferably 5 parts by mass or less, and particularly preferably 3 parts by mass or less, relative to 100 parts by mass of the total polybutylene terephthalate resin (A) and polystyrene or rubber-reinforced polystyrene resin (B).

In addition, the present invention can contain a variety of additives in addition to those mentioned above, and examples of such additives include flame retardant (and especially brominated phthalimide, brominated polyacrylate, brominated polycarbonate, brominated epoxy compound, brominated polystyrene, and the like), auxiliary flame retardant (and especially antimony trioxide or the like), anti-dripping agent, ultraviolet radiation absorber, anti-static agent, anti-fogging agent, anti-blocking agent, plasticizer, dispersing agent, antimicrobial agent, coloring agent, dye and pigment.

An extruder, and preferably a twin screw extruder, is used in the method for producing thermoplastic resin composition pellet of the present invention. A variety of twin screw extruders can be used, and the screw rotation type can be co-rotating or counter-rotating, but a co-directional meshing type twin screw extruder is preferred. The screw length and diameter, meshing ratio, and so on, of the twin screw extruder can be arbitrary or arbitrarily set. In addition, a vent opening which can be decompressed or opened to the atmosphere may be provided in the twin screw extruder.

The first method of the present invention for producing thermoplastic resin composition pellet is a method for producing thermoplastic resin composition pellet using an extruder, and is characterized by mixing and melting the polybutylene terephthalate resin (A) and the polystyrene or rubber-reinforced polystyrene resin (B), and then adding the heat-expandable microsphere (C).

The polybutylene terephthalate resin (A) and the polystyrene or rubber-reinforced polystyrene resin (B) are supplied from a supply port at the base of the extruder, and both resins are mixed and melted using a first kneading unit. The heat-expandable microsphere (C) or master batch thereof are not supplied all at once together with components (A) and (B) to the supply port at the base of the extruder, but are side fed after the polybutylene terephthalate resin (A) and the polystyrene or rubber-reinforced polystyrene resin (B) have been melted.

In the extruder, kneading takes place in the first kneading unit towards the downstream side from the supply port at the base of the extruder, and the heat-expandable microspheres (C) or master batch thereof are side fed from a part that is downstream from the first kneading unit. The position at which the heat-expandable microspheres (C) or master batch thereof are introduced is such that the distance S from the downstream tip of the extruder to the position at which the heat-expandable microsphere (C) are introduced is preferably not more than half the total length L of the extruder, and is preferably such that the S/L ratio falls within the range 0.05 to 0.5, and more preferably within the range 0.05 to 0.4.

Here, the total length L of the extruder means the total length of screws that transport, knead and melt the components mentioned above, and more specifically means the length from the supply part (hopper) at the base of the extruder to the tip of the screws. In addition, the distance S from the downstream tip of the extruder to the position at which the heat-expandable microspheres (C) are introduced means the distance from the downstream tip of the extruder to the central part of an inlet port where the heat-expandable microspheres (C) or master batch thereof are introduced, and more specifically means the length from the tip of the screws (C) to the center of an opening for introducing the heat-expandable microspheres (C) or master batch thereof.

Components (A), (B) and (C) are then melt kneaded in a kneading unit on the downstream side. The heating temperature at the time of melt kneading is such that the maximum cylinder temperature is preferably 250° C. and the resin temperature preferably falls within the range 210 to 240° C., and is more preferably 215° C. or higher, and further preferably 220° C. or higher, and is more preferably 235° C. or lower. By using such conditions, it is possible to homogeneously disperse the components while suppressing foaming during production of the resin composition pellet.

In cases where the inorganic filler (D) is blended, and especially cases where a fibrous inorganic filler is blended, side feeding is preferable, and it is preferable to side feed the inorganic filler after the polybutylene terephthalate resin (A) and the polystyrene or rubber-reinforced polystyrene (B) have been melted, and then side feed the heat-expandable microsphere (C) or master batch.

After the melt kneading, a strand is extruded from a nozzle of a die plate at the tip of the extruder, and the strand is cooled and then cut with a cutter to obtain thermoplastic resin composition pellet.

The second method of the present invention for producing thermoplastic resin composition pellet is a method for producing thermoplastic resin composition pellet using an extruder, and is characterized by including a step for melt kneading a master batch comprising the heat-expandable microsphere (C) and a thermoplastic resin with the polybutylene terephthalate resin (A) and the polystyrene or rubber-reinforced polystyrene resin (B).

The polybutylene terephthalate resin (A) and the polystyrene or rubber-reinforced polystyrene resin (B) are supplied from a supply port at the base of the extruder, and the resins are melted using a first kneading unit. The master batch comprising the heat-expandable microsphere (C) and a thermoplastic resin may be supplied all at once from the supply port at the base of the extruder together with the polybutylene terephthalate resin (A) and the polystyrene or rubber-reinforced polystyrene resin (B), but may also be side fed after components (A) and (B) have been melted. Components (A), (B) and (C) are then melt kneaded in a second kneading unit that is further downstream. The heating temperature at the time of melt kneading is such that the maximum cylinder temperature is preferably 250° C. and the resin temperature preferably falls within the range 210 to 245° C., and is more preferably 215° C. or higher, and further preferably 220° C. or higher, and is more preferably 235° C. or lower. By using such conditions, it is possible to homogeneously disperse the components while suppressing foaming during production of the resin composition pellet.

After the melt kneading, a strand is extruded from a nozzle of a die plate at the tip of the extruder, and the strand is cooled and then cut with a cutter to obtain thermoplastic resin composition pellets.

### [Molded Body]

Although not particularly limited, the thermoplastic resin composition pellet of the present invention can be molded using any molding method commonly used for thermoplastic resin compositions. Examples thereof include injection molding method, ultra-high-speed injection molding method, injection compression molding method, two-color molding method, blow molding method such as gas-assisted method, molding method that uses heat insulating mold, molding method that uses rapidly heated mold, foam molding method (including supercritical fluid), insert molding method, IMC (in-mold coating) molding method, extrusion molding method, sheet molding method, thermoforming method, rotational molding method, lamination molding method, press molding method and blow molding method.

Among these, the thermoplastic resin composition pellet of the present invention is preferred as a material for injection molding, and is suitable as a material for foam molding used for producing a foam molded body.

### [Foam Molded Body]

Method for producing foam molded bodies using the thermoplastic resin composition pellet of the present invention is not particularly limited, and it is possible to use any molding method commonly used for thermoplastic resin composition, examples of which include well-known method such as extrusion foam molding, injection foam molding, press foam molding and in-mold foam molding. Among these, injection foam molding is preferred from the perspectives of achieving excellent productivity and exhibiting the advantageous effects of the present invention. Preferred examples of injection foam molding method include: short shot method comprising injecting and filling pellets into a mold cavity and filling a void in the mold cavity as a result of expansion pressure caused by the heat-expandable microsphere (C); and core back method comprising injecting and filling pellets into a mold cavity whose capacity can be changed, retracting the movable mold, and filling a void in the mold cavity as a result of expansion pressure caused by the heat-expandable microsphere (C).

The thermoplastic resin composition pellet of the present invention is preferably such that the decrease rate (change rate) of the specific gravity of a foam molded article relative to the specific gravity of an unfoamed molded article is 15% or more. The specific gravity decrease rate, which is a foam weight reduction effect, means a percentage reduction in specific gravity (%), which is determined by dividing the specific gravity (g/cm³) of an obtained foam molded article by the specific gravity (g/cm³) of an unfoamed molded article. The specific gravity decrease rate, which is a foam weight reduction effect, is more preferably 16% or more, further preferably 17% or more, and particularly preferably 18% or more, and is preferably 60% or less, more preferably 50% or less, further preferably 45% or less, and particularly preferably 40% or less. An unfoamed molded article can be obtained by, for example, molding by applying a high pressure that is at least 50% of the peak injection pressure at the time of injection molding.

Foam molded body obtained in this way achieves a high weight reduction effect, have a favorable molded article form, does not have problems such as sinks or warping, and exhibits excellent heat resistance, and can therefore be advantageously used as components of electrical and electronic devices, components fitted to motor vehicles, and other electrical components, for which there are strict requirements in terms of these characteristics.

Examples of components of electrical and electronic devices include housing component such as relay cases, smart meter housing, industrial breaker housing, inverter case, cellphone housing, heater housing, IH cooker housing, button case, grill handle, coil periphery component, protective frame for rice cooker, battery separator, battery case, tray for transporting electronic component, tray for transporting battery, and motor vehicle charging equipment component.

Preferred examples of molded component fitted to motor vehicle include a variety of housing fitted to motor vehicle, such as housing for engine control unit (ECU), housing for head up display fitted to motor vehicle, case, cover and separator for battery fitted to motor vehicle, a variety of motor case, sensor case, camera case, holder component, wind direction control panel for air conditioner, door mirror stay, door trim, and component for electrical connector in motor vehicle.

### EXAMPLES

The present invention will now be explained in greater detail through the use of examples. However, it should be understood that the present invention is not limited to the examples given below.

Raw material components used in the examples and comparative examples below are as shown in Table 1 below.

TABLE 1

| Component | Sym. | |
|---|---|---|
| (A)PBT resin | A1 | Polybutylene terephthalate resin, |
| | | IV = 0.70 dl/g |
| | AX | Polybutylene terephthalate resin, |
| | | IV = 1.50 dl/g |
| (B)Polystyrene | B1 | HIPS, melt viscosity = 132 Pa · s |
| or HIPS | | at 250° C. and 912 sec⁻¹ |
| | B2 | Polystyrene, melt viscosity = 64 Pa · s |
| | | at 250° C. and 912 sec⁻¹ |
| (C) | C1 | Heat-expandable microcapsules |
| Heat-expandable | | “Matsumoto Microspheres F-2860D” |
| microsphere | | by Matsumoto Yushi-Seiyaku Co. |
| | | Maximum expansion temp: 270° C., |
| | | average particle diameter: 25 μm |
| | | Expansion initiation temp: 250° C. |
| | C2 | Heat-expandable microcapsule master batch |
| | | “Matsumoto Microspheres MBF-2860PE” |
| | | by Matsumoto Yushi-Seiyaku Co. |
| | | 50 mass % of F-2860D (maximum |
| | | expansion temp: 270° C.) and |
| | | 50 mass % of olefinic resin |
| | CX | Heat-expandable microcapsules |
| | | Matsumoto Microspheres F-190D” |
| | | by Matsumoto Yushi-Seiyaku Co. |
| | | Maximum expansion temp: 215° C., |
| | | average particle diameter: 35 μm |
| | | Expansion initiation temp: 165° C. |
| (D)Inorganic | D1 | Carbon fiber |
| filler | | “TR06UL” by Mitsubishi Chemical |
| | | Corp., fiber diameter: 6 μm |
| | D2 | Glass fiber |
| | | “3PA830S” by Nitto Boseki Co., |
| | | short axis: 7 μm, long axis: 28 μm |
| (E)Compatibilizer | E1 | Polycarbonate resin Mv = 16,000 |
| | | “Iupilon H4000” by Mitsubishi |
| | | Engineering-Plastics Corp. |
| Phosphorus | F1 | Octadecyl acid phosphate “AX-71” |
| stabilizer | | by ADEKA |
| Phenolic | F2 | Hindered phenol antioxidant “AO-60” |
| stabilizer | | by ADEKA |
| Mold-release | G1 | Oxidized polyethylene wax “Licowax |
| agent | | PED 522” by Clariant |
| CB-MB | H1 | Carbon black master batch |
| | | Polybutylene terephthalate base/CB |
| | | concentration 19% |

### Examples 1 to 5 and Comparative Examples 1 to 3

Among the components shown in Table 1 above, components other than components (C) and (D) were homogeneously mixed at proportions (pass by mass) shown in Table 2 below using a tumbler mixer, and then fed from a first supply port located at the base of a twin screw extruder (a “TEM41SX” produced by Shibaura Machine Co., Ltd.; total length L of extruder=246 mm; L/D=60). Component (C) was side fed after component (D) had been side fed.

The components were melt kneaded at a maximum preset cylinder temperature of 250° C., a resin temperature shown in Table 2, a discharge rate of 100 kg/h and a screw rotation speed of 170 rpm, and extruded as a strand from a die nozzle at the tip of the extruder, and the strand was slowly cooled on a mesh belt and then pelletized using a pelletizer to obtain pellets of a thermoplastic resin composition.

### [Evaluation of Heat Resistance of Pellet]

The thus obtained pellets were placed in an oven at a temperature of 120° C. and dried for 6 hours, and when the pellets were removed from the oven it was observed whether or not pellets had fused to each other, and heat resistance was assessed by evaluating a case where fusing did not occur as A and a case where pellet fused to each other as C.

### [Evaluation of Appearance of Pellet]

20 g of pellets obtained in the manner described above were selected by eye and assessed according to the following criteria.
A: White foreign objects having diameters of 1 mm or more were not observed.
B: Not more than 5 g of pellets in which white foreign objects having diameters of 1 mm or more were observed.
C: More than 5 g of pellets in which white foreign objects having diameters of 1 mm or more were observed.

### [Injection Foam Molding]

The thus obtained resin composition pellets were dried for 6 hours at 120° C. in advance, and then subjected to injection foam molding by means of a short shot method using a J85AD injection molding machine produced by Japan Steel Works, Ltd., which was equipped with a shutoff nozzle, thereby obtaining a foam molded article having a thickness of 3 mm, a height of 40 mm and a width of 120 mm. Molding was carried out at a cylinder temperature of 260° C., a mold temperature of 80° C., an injection speed of 100 mm/see and 300 mm/see, a cooling time of 20 seconds, a back pressure of 5 MPa, and a holding pressure of 0 MPa.

### [Evaluation of Sinks in Foam Molded Article]

Following the injection foam molding described above, the presence or absence of sinks in a foam molded article was observed by eye and assessed using the following criteria.
A: Sinks were not observed
B: 1 to 5 fine sinks having diameters of less than 3 mm
C: Large sinks having diameters of 3 mm or more were present, or six or more fine sinks having diameters of less than 3 mm

### [Evaluation of Specific Gravity of Foam Molded Article and Foam Weight Reduction Effect]

The specific gravity (g/cm³) of an obtained foam molded article was measured and divided by the specific gravity (g/cm³) of an unfoamed molded article to give a specific gravity decrease rate (%), which is shown in a Table 2 as foam weight reduction effect (%). An unfoamed molded article can be obtained by, for example, molding by applying a high pressure that is at least 50% of the peak injection pressure at the time of injection molding. The specific gravity of a molded article was measured by means of a weight-in-water method using an “AW320 tabletop electronic analytical balance” produced by Shimadzu Corporation.

### [Evaluation of Warpage]

A circular disk having a diameter of 100 mm and a thickness of 1.6 mm was molded using a side gate mold in an injection molding machine (an NEX80 produced by Nissei Plastic Industrial Co., Ltd.) at a cylinder temperature of 260° C., a mold temperature of 80° C. and an injection time of 0.5 sec, and the warpage amount (units: mm) of the circular disk was determined and evaluated using the criteria shown below. The holding pressure was 80% of the peak pressure.
A: warpage amount of less than 2.0 mm
B: warpage amount of 2.0 mm or more and 10.0 mm or less
C: warpage amount of more than 10.0 mm

The results of these evaluations are shown in Table 2 below.

TABLE 2

| | | Example | | | | | Comp. Ex. | | |
|---|---|---|---|---|---|---|---|---|---|
| | Sym | 1 | 2 | 3 | 4 | 5 | 1 | 2 | 3 |
| (A)PBT resin | A1 | 38 | 38 | 38 | 100 | 38 | 38 | 38 | |
| | AX | | | | | | | | 38 |
| (B)Polystyrene or HIPS | B1 | 62 | 62 | 62 | | 62 | 62 | 62 | |
| | B2 | | | | | | | | 62 |
| (C)Heat-expandable | C1 | 3.3 | | | 2.9 | | | | 3.3 |
| microsphere | C2 | | 6.8 | 6.8 | | 15.1 | | | |
| | CX | | | | | | | 3.3 | |
| (D)Inorganic filler | D1 | 13.2 | 13.6 | 13.6 | 11.7 | | 12.8 | 13.2 | 13.2 |
| | D2 | | | | | 56.5 | | | |
| (E)Compatibilizer | E1 | 12.7 | 12.7 | 12.7 | | 12.7 | 12.7 | 12.7 | |
| Phosphorus stabilizer | F1 | 0.13 | 0.14 | 0.14 | | 0.19 | 0.13 | 0.13 | 0.13 |
| Phenolic stabilizer | F2 | 0.40 | 0.41 | 0.41 | 0.35 | 0.57 | 0.39 | 0.40 | 0.40 |
| Mold-release agent | G1 | 0.66 | 0.68 | 0.68 | 0.59 | 0.94 | 0.64 | 0.66 | 0.66 |
| CB-MB | H1 | 1.72 | 1.77 | 1.77 | 1.52 | 2.45 | 1.67 | 1.72 | 1.72 |

| | | | | | | | | |
|---|---|---|---|---|---|---|---|---|
| Specific gravity [g/cm³] | 0.88 | 0.95 | 0.99 | 1.06 | 1.17 | 1.18 | 1.18 | 0.90 |
| Foam weight reduction effect [%] | 26 | 19 | 16 | 23 | 15 | 0 | 0 | 24 |
| Pellet heat resistance | A | A | A | A | A | A | A | C |
| Pellet appearance | A | B | A | A | A | A | A | A |
| Sink marks in foam-molded article | A | A | A | A | A | C | C | A |
| (Injection speed 100 mm/sec) | | | | | | | | |
| Sink marks in foam-molded article | A | B | B | A | A | C | C | A |
| (Injection speed 300 mm/sec) | | | | | | | | |
| Warpage | A | A | A | B | A | A | A | A |

### Examples 1-1 to 1-5 and Comparative Example 1-1: Examples and Comparative Example Relating to the First Method of the Present Invention

Among the components shown in Table 1 above, components other than components (C) and (D) were homogeneously mixed at proportions (pass by mass) shown in Table 3 below using a tumbler mixer, and then fed from a first supply port located at the base of a twin screw extruder (“TEM41SX” produced by Shibaura Machine Co., Ltd.; total length L of extruder=246 mm; L/D=60). After component (D) was side fed, component (C) was side fed from an introduction position S shown in Table 3 (a distance cm from the tip of the screw on the downstream side), as shown in Table 3 (“Separately” in Table 3).

The components were melt kneaded at a maximum preset cylinder temperature of 250° C., a resin temperature shown in Table 3, a discharge rate of 100 kg/h and a screw rotation speed of 180 rpm, and extruded as a strand from a die nozzle at the tip of the extruder, and the strand was slowly cooled on a mesh conveyor belt and then pelletized using a pelletizer to obtain pellets of a thermoplastic resin composition.

Evaluations were carried out in the same way as described above. The results are shown in Table 3 below.

TABLE 3

| | | Example | | | | | Comp.Ex. |
|---|---|---|---|---|---|---|---|
| | Sym | 1-1 | 1-2 | 1-3 | 1-4 | 1-5 | 1-1 |
| (A)PBT resin | A1 | 38 | 38 | 38 | 100 | 38 | |
| | AX | | | | | | 38 |
| (B)Polystyrene or HIPS | B1 | 62 | 62 | 62 | | 62 | |
| | B2 | | | | | | 62 |
| (C)Heat-expandable | C1 | 3.3 | | | 2.9 | | 3.3 |
| microsphere | C2 | | 6.8 | 6.8 | | 15.1 | |
| (D)Inorganic filler | D1 | 13.2 | 13.6 | 13.6 | 11.7 | | 13.2 |
| | D2 | | | | | 56.5 | |
| (E)Compatibilizer | E1 | 12.7 | 12.7 | 12.7 | | 12.7 | |
| Phosphorus stabilizer | F1 | 0.13 | 0.14 | 0.14 | | 0.19 | 0.13 |
| Phenolic stabilizer | F2 | 0.40 | 0.41 | 0.41 | 0.35 | 0.57 | 0.40 |
| Mold-release agent | G1 | 0.66 | 0.68 | 0.68 | 0.59 | 0.94 | 0.66 |
| CB-MB | H1 | 1.72 | 1.77 | 1.77 | 1.52 | 2.45 | 1.72 |

| | | | | | | |
|---|---|---|---|---|---|---|
| Method for feeding (C) | Separately | Separately | Separately | Separately | Separately | Separately |
| Distance S cm | 24 | 24 | 60 | 24 | 24 | 24 |
| from downstream distal end | | | | | | |
| to position of introduction of (C) | | | | | | |
| Total length of extruder (cm) | 246 | 246 | 246 | 246 | 246 | 246 |
| S/L | 0.10 | 0.10 | 0.30 | 0.10 | 0.10 | 0.10 |
| Resin temperature [° C.] | 224 | 230 | 230 | 235 | 220 | 232 |
| Specific gravity [g/cm³] | 0.88 | 0.95 | 0.99 | 1.06 | 1.17 | 0.90 |
| Foam weight reduction effect [%] | 26 | 19 | 16 | 23 | 15 | 24 |
| Pellet heat resistance | A | A | A | A | A | C |
| Pellet appearance | A | B | A | A | A | A |
| Sink marks in foam-molded article | A | A | A | A | A | A |
| (Injection speed 100 mm/sec) | | | | | | |
| Sink marks in foam-molded article | A | B | B | A | A | A |
| (Injection speed 300 mm/sec) | | | | | | |
| Warpage | A | A | A | B | A | A |

### Examples 2-1 to 2-5 and Comparative Example 2-1: Examples and Comparative Example Relating to the Second Method of the Present Invention

Among the components shown in Table 1 above, components other than components (C) and (ID) were homogeneously mixed at proportions (pass by mass) shown in Table 4 below using a tumbler mixer, and then fed from a first supply port located at the base of a twin screw extruder (“TEM41SX” produced by Shibaura Machine Co., Ltd.; L/D=60). As shown in Table 4, component (C) was fed from a first supply port at the base of the extruder together with components other than component (D) (“Together” in Table 4) or side fed after component (D) had been side fed (“Separately” in Table 4). The components were melt kneaded at a maximum preset cylinder temperature of 250° C., a resin temperature shown in Table 4, a discharge rate of 100 kg/h and a screw rotation speed of 170 rpm, and extruded as a strand from a die nozzle at the tip of the extruder, and the strand was slowly cooled on a mesh belt and then pelletized using a pelletizer to obtain pellets of a thermoplastic resin composition.

Evaluations were carried out in the same way as described above, and the flexural modulus of elasticity of a foam molded article was also evaluated using the method described below.

### [Evaluation of Flexural Modulus of Elasticity of Foam Molded Article]

A test piece having a height of 10 mm and a width of 80 mm was punched out from the center of a foam molded article described above, and the flexural modulus of elasticity (units: MPa) of this test piece was measured at a temperature of 23° C. using IS0178 as a reference.

The results are shown in Table 4 below.

TABLE 4

| | | Example | | | | | Comp. Ex. |
|---|---|---|---|---|---|---|---|
| | Sym | 2-1 | 2-2 | 2-3 | 2-4 | 2-5 | 2-1 |
| (A)PBT resin | A1 | 38 | 38 | 38 | 38 | 100 | |
| | AX | | | | | | 38 |
| (B)Polystyrene or HIPS | B1 | 62 | 62 | 62 | 62 | | 62 |
| (C)Heat-expandable | C2 | 6.8 | 11.3 | 6.8 | 15.1 | 6.0 | 15.1 |
| microsphere | CX | | | | | | |
| (D)Inorganic filler | D1 | 13.6 | 14.1 | 13.6 | | 12.1 | |
| | D2 | | | | 56.5 | | 56.5 |
| (E)Compatibilizer | E1 | 12.7 | 12.7 | 12.7 | 12.7 | | 12.7 |
| Phosphorus stabilizer | F1 | 0.14 | 0.14 | 0.14 | 0.19 | | 0.19 |
| Phenolic stabilizer | F2 | 0.41 | 0.42 | 0.41 | 0.57 | 0.36 | 0.57 |
| Mold-release agent | G1 | 0.68 | 0.71 | 0.68 | 0.94 | 0.60 | 0.94 |
| CB-MB | H1 | 1.77 | 1.84 | 1.77 | 2.45 | 1.57 | 2.45 |

| | | | | | | |
|---|---|---|---|---|---|---|
| Method for supplying (C) | Together | Together | Separately | Separately | Together | Together |
| Maximum cylinder temperature [° C.] | >250 | >250 | >250 | >250 | >250 | >250 |
| Resin temperature [° C.] | 230 | 230 | 230 | 220 | 235 | >250 |
| Specific gravity [g/cm³] of | 1.03 | 0.94 | 0.95 | 1.17 | 1.21 | 1.33 |
| foam-molded article | | | | | | |
| Foam weight reduction effect [%] | 12 | 20 | 19 | 15 | 12 | 3 |
| Pellet heat resistance | A | A | A | A | A | C |
| Sink marks in foam-molded article | A | A | A | A | A | C |
| (Injection speed 100 mm/sec) | | | | | | |
| Flexural modulus of elasticity (MPa) | 5690 | 5460 | 5500 | 5450 | 5750 | 5700 |
| Warpage | A | A | A | A | B | A |

### INDUSTRIAL APPLICABILITY

The thermoplastic resin composition pellet of the present invention can be foam molded on a molding company without using a foaming agent at the time of molding, and a thus produced foam molded article has a high weight reduction effect and also has a favorable form, and therefore has particularly high usability for foam molding a variety of components, such as components of electrical and electronic devices and components fitted to motor vehicles, for which weight reduction is required.

1. A thermoplastic resin composition pellet, comprising,
a polybutylene terephthalate resin (A) in a range of from 30 to 100 parts by mass, the polybutylene terephthalate resin (A) having an intrinsic viscosity in a range of from 0.3 to 1.3 dl/g;
a polystyrene or a rubber-reinforced polystyrene resin (B) in a range of from 0 to 70 parts by mass; and
a heat-expandable microsphere (C) in a range of from 0.5 to 20 parts by mass, relative to 100 parts by mass of a total (A) and (B) mass of the polybutylene terephthalate resin (A) and the polystyrene or rubber-reinforced polystyrene resin (B),
wherein a maximum expansion temperature of the heat-expandable microsphere (C), is in a range of from 250 to 320° C., and
wherein an average particle diameter of the heat-expandable microsphere (C) is in a range of from 10 to 50 μm.

2. The pellet of claim 1, which is suitable as a material for injection molding.

3. The pellet of claim 1, further comprising:
an inorganic filler (D) in a range of from 10 to 100 parts by mass, relative to 100 parts by mass of the total (A) and (B) mass.

4. The pellet of claim 1, wherein the polystyrene or rubber-reinforced polystyrene resin (B) has a melt viscosity at 250° C. and 912 sec⁻¹ in a range of from 80 to 500 Pa·s.

5. The pellet of claim 3, wherein the inorganic filler (D) is a fibrous filler.

6. The pellet of claim 1, further comprising:
a polycarbonate resin as a compatibilizer (E) in a range of from 0 to 30 parts by mass, relative to 100 parts by mass of the total (A) and (B) mass.

7. A molded article, obtained by foam molding the pellet of claim 1.

8. The molded article of claim 7, wherein a decrease rate of a specific gravity of a foam molded article relative to a specific gravity of an unfoamed molded article is 15% or more.

9. The molded article of claim 7, which is a molded component configured to be installed to a motor vehicle.

10. A method for producing a thermoplastic resin composition pellet by using an extruder,
the method comprising: mixing and melting a polybutylene terephthalate resin (A) and a polystyrene or rubber-reinforced polystyrene resin (B), and then adding a thermally expandable microspherical particle (C),
wherein the thermoplastic resin composition pellet comprises
the polybutylene terephthalate resin (A) in a range of from 30 to 100 parts by mass, the polybutylene terephthalate resin (A) having an intrinsic viscosity in a range of from 0.3 to 1.3 dl/g,
the polystyrene or a rubber-reinforced polystyrene resin (B) in a range of from 0 to 70 parts by mass, and
the heat-expandable microsphere (C) in a range of from 0.5 to 20 parts by mass, relative to 100 parts by mass of a total (A) and (B) mass of the polybutylene terephthalate resin (A) and the polystyrene or rubber-reinforced polystyrene resin (B).

11. A method for producing a thermoplastic resin composition pellet by using an extruder,
the method comprising:
melt kneading a master batch comprising a heat-expandable microsphere (C) and a thermoplastic resin with a polybutylene terephthalate resin (A) and a polystyrene or rubber-reinforced polystyrene resin (B),
wherein the thermoplastic resin composition pellet comprises
the polybutylene terephthalate resin (A) in a range of from 30 to 100 parts by mass, the polybutylene terephthalate resin (A) having an intrinsic viscosity in a range of from 0.3 to 1.3 dl/g,
the polystyrene or a rubber-reinforced polystyrene resin (B) in a range of from 0 to 70 parts by mass, and
the heat-expandable microsphere (C) in a range of from 0.5 to 20 parts by mass, relative to 100 parts by mass of a total (A) and (B) mass of the polybutylene terephthalate resin (A) and the polystyrene or rubber-reinforced polystyrene resin (B).

12. The method of claim 10, further comprising:
blending an inorganic filler (D) in a range of 10 to 100 parts by mass relative to 100 parts by mass of the total (A) and (B) mass.

13. The method of claim 12, further comprising:
side-feeding the inorganic filler (D), mixing, and then blending the heat-expandable microsphere (C) or a master batch including the heat-expandable microsphere (C) and a thermoplastic resin.

14. The method of claim 12, wherein the inorganic filler (D) is a fibrous filler.

15. The method of claim 10, further comprising:
incorporating a compatibilizer (E) in a range of from 5 to 50 parts by mass, relative to 100 parts by mass of the total (A) and (B) mass.

16. The method of claim 10, wherein the heat-expandable microsphere (C) has a maximum expansion temperature in a range of from 250 to 320° C.

17. The method of claim 10, wherein a resin temperature immediately after leaving the extruder is in a range of from 200 to 275° C.

18. The method of claim 10, wherein a distance S from a tip of the extruder to a position, at which the heat-expandable microsphere (C) is fed, relative to an overall length L of the extruder is such that a value of S/L is in a range of from 0.05 to 0.5.

19. The method of claim 10, wherein the polystyrene or rubber-reinforced polystyrene resin (B) has a melt viscosity at 250° C. and 912 sec⁻¹ in a range of from 80 to 500 Pa·s.
